(19) United States
(12) Patent Application Publication
(10) Pub. No.: US 2004/0257458 A1
(43) Pub. Date: Dec. 23, 2004

(54) Aspect-ratio adjustable viewfinder and view-finding method of the same

(76) Inventors: Max Huang, Taipei (TW); Tzu Hung Cheng, Taipei (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/729,656

(22) Filed: Dec. 5, 2003

(30) Foreign Application Priority Data
Jun. 19, 2003 (TW) 092116712

(51) Int. Cl. H04N 5/222

(52) U.S. Cl. 348/333.01

(57) ABSTRACT

A view-finding method of an image-capturing apparatus includes the following steps. Firstly, a desired one from a plurality of predetermined aspect ratios is selected. Then, an image frame to be taken by the image-capturing apparatus is shown and marked according to the selected aspect ratio to distinguish a desired frame portion from the other frame portion. Moreover, a view-finding device includes an image display window, an input interface and a micro-controller. The image display window shows an image frame to be taken by the image-capturing apparatus. The input interface allows a user to give a command therevia for designating an aspect ratio. The micro-controller is in communication with the input interface, and has the image frame to be marked in a specific pattern in response to the command

### FIELD OF THE INVENTION

The present invention relates to a view-finding method and a view-finding device, and more particularly to a view-finding method and a view-finding device, e.g. digital still cameras or video cameras, capable of adjusting the aspect ratio of a frame viewed thereby.

### BACKGROUND OF THE INVENTION

Typical digital still cameras or video cameras capture digital image in the aspect ratio of 4 by 3. For example, the common resolutions of digital still cameras or video cameras are 800 by 600 pixels, 1024 by 768 pixels, 1280 by 960 pixels, 1600 by 1200 pixels, etc. When the captured digital image is to be developed or printed as a photo, it is required to comply with the photo specifications, e.g. an aspect ratio of 5 by 3 or 6 by 4. Therefore, some problems occur due to the unmatched aspect ratios of the viewed frame and the real photograph. For example, by means of an image processing software, the aspect ratio of a digital image can be adjusted to conform to the photograph specification. However, the image will be distorted accordingly. Alternatively, the captured image frame can be directly scaled into the photo specification prior to being developed or printed. Under this circumstance, blank edges will be retained in the photo if the entire image is to be reserved or the image has to be partially trimmed if blank edges are undesired. Since the digital image data need to be downloaded and processed by a computer in advance in the above-mentioned alternative, it is troublesome and inefficient.

For some digital still cameras or the video cameras, the captured image can be directly adjusted to conform to the aspect ratio of a photograph while taking pictures, for example either 5 by 3 or 6 by 4. This manner, however, is disadvantageous for obtaining photographs that are not in that specific aspect ratio.

### SUMMARY OF THE INVENTION

It is an object of the present invention to provide a view-finding method and a view-finding device capable of adjusting the aspect ratio of a frame viewed thereby according to the desired photo specification.

It is another object of the present invention to provide a view-finding method and a view-finding device permitting flexible adjustment of the aspect ratio of a frame viewed thereby according to the desired photo specification.

In accordance with a first aspect of the present invention, there is provided a view-finding method of an image-capturing apparatus. A desired one from a plurality of predetermined aspect ratios is firstly selected. Then, an image frame to be taken by the image-capturing apparatus is shown and marked according to the selected aspect ratio to distinguish a desired frame portion from the other frame portion.

Preferably, the step of selecting the desired aspect ratio is performed by the user via an input interface.

In an embodiment, the input interface is a button.

For example, the image-capturing apparatus can be a digital still camera or a digital video camera for obtaining a digital data file of the image frame.

Preferably, digital information associated with the selected aspect ratio is recorded into the digital data file. The digital data file can be outputted to be shown on a monitor or processed into a picture.

In an embodiment, the image frame is marked with a relatively bright and a relatively dark portions to show the desired frame portion and an undesired frame portion, respectively.

In an embodiment, the image frame is marked with segmental symbols to define the desired frame portion.

In accordance with a second aspect of the present invention, there is provided a view-finding device of an image-capturing apparatus. The view-finding device comprises an image display window, an input interface and a micro-controller. The image display window shows an image frame to be taken by the image-capturing apparatus. The input interface allows a user to give a command therevia for designating an aspect ratio. The micro-controller is in communication with the input interface, and has the image frame to be marked in a specific pattern in response to the command.

Preferably, the view-finding device further comprises a storage unit for storing a digital image data file of the image frame, which incorporates therein the information associated with the aspect ratio.

In an embodiment, the storage unit is a flash memory.

In an embodiment, the image display window is a viewfinder or a liquid crystal display.

In accordance with a third aspect of the present invention, there is provided a view-finding device of an image-capturing apparatus. The view-finding device comprises an image display window showing an image frame to be taken by the image-capturing apparatus, wherein the image frame is marked thereon with plural sets of symbols to define a plurality of frame portions corresponding to a plurality of predetermined aspect ratios.

In an embodiment, the symbols are segmental symbols.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a diagram schematically illustrating the rearview of a digital still camera according to the present invention;

FIG. 2 is a functional block diagram illustrating a view-finding device according to the present invention;

FIGS. 3(a) and 3(b) are schematic diagrams illustrating various marks provided on an image frame to specify frame portions in different aspect ratios according to a preferred embodiment of the present invention;

FIGS. 4(a) and 4(b) are schematic diagrams illustrating various marks provided on an image frame to specify frame portions in different aspect ratios according to another preferred embodiment of the present invention; and

FIG. 4(c) is a schematic diagram illustrating the presence of plural sets of marks to simultaneously specify frame portions in different aspect ratios according to a further preferred embodiment of the present invention.

### DETAILED DESCRIPTION OF THE PREFERRED EMBODIMENT

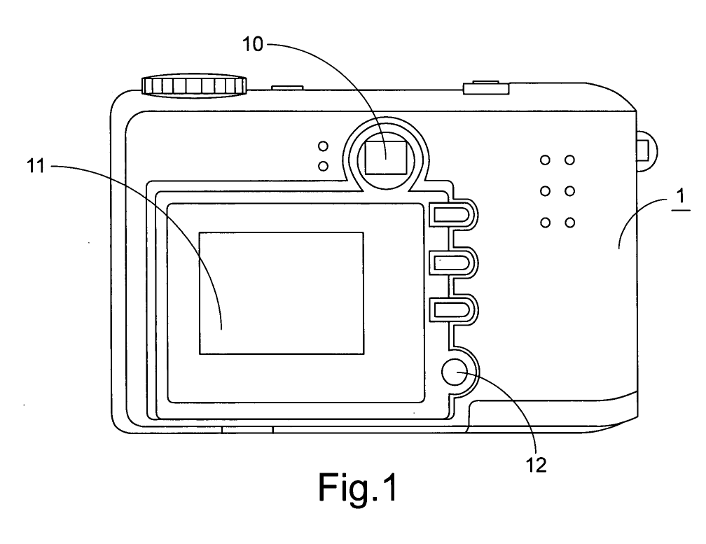

Referring to FIG. 1, a schematic rear view of a digital still camera 1 according to the present invention is shown. An image frame to be captured is viewed via a viewfinder 10 or a planar liquid crystal display 11. The input interface 20, e.g. a button, is provided for the user to enter a command so as to pick the desired aspect ratio from a plurality of preset ratios. In response to the desired aspect ratio, the image frame is properly marked.

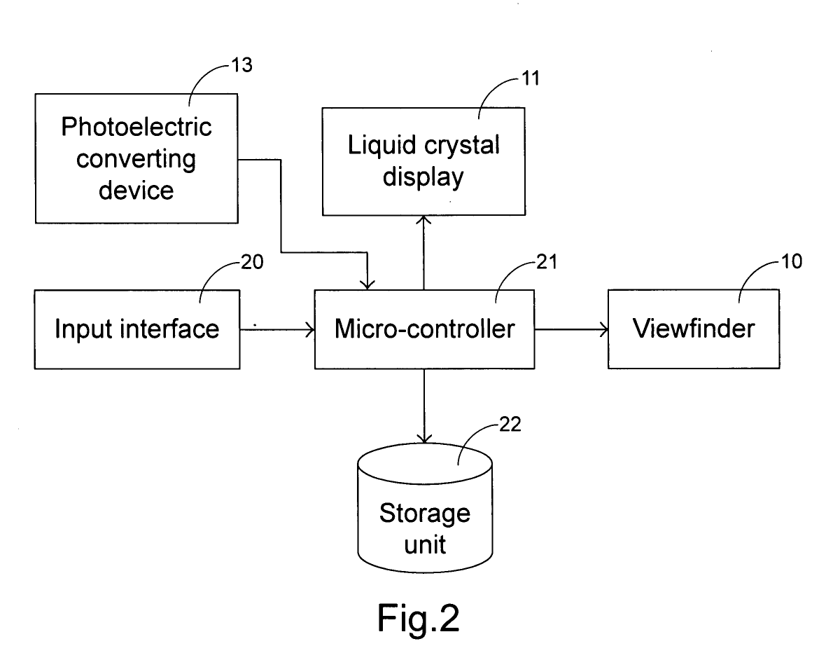

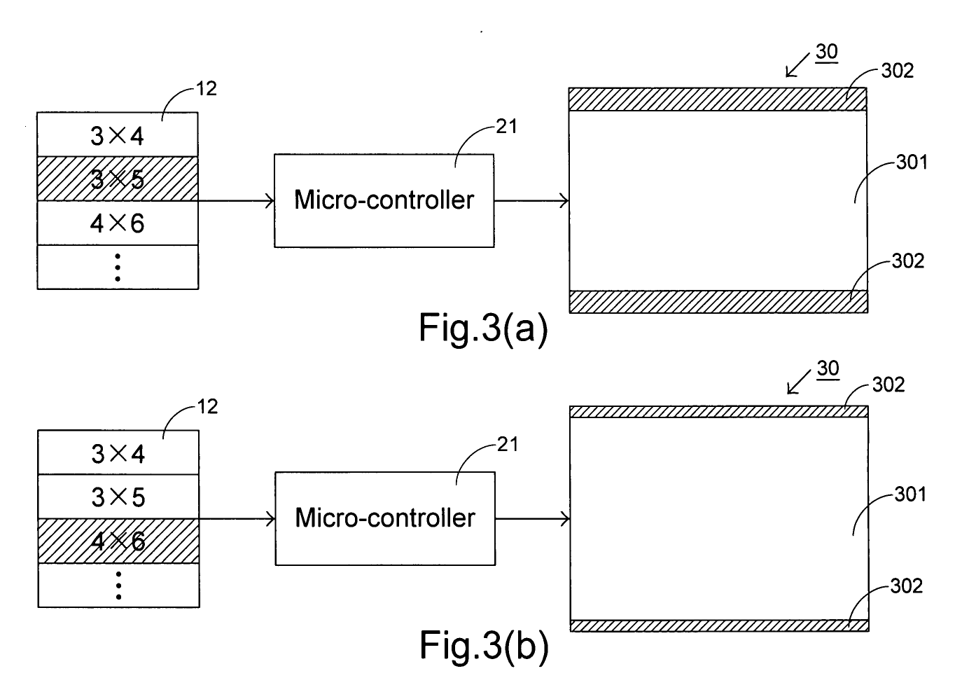

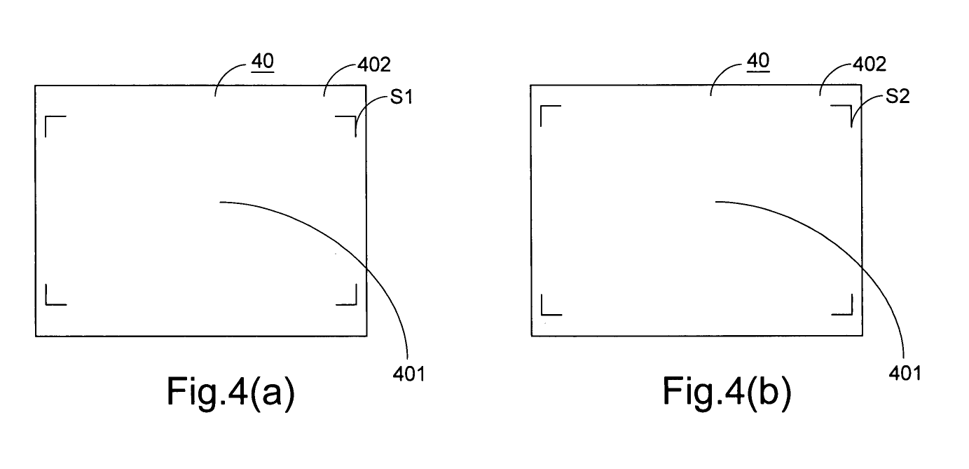

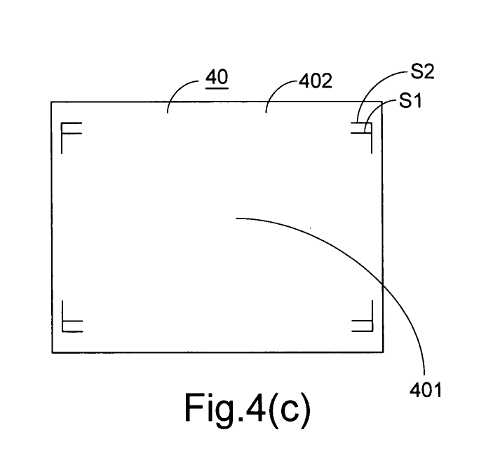

As shown in FIG. 2, after an aspect-ratio-related command is entered by the user via the input interface 20, a micro-controller 21 has the image frame captured by the photoelectric converting device 13 to be marked in a specific pattern in response to the command. The mark associated with the aspect ratio is then incorporated into a digital image data file of the image frame, which is stored in a storage unit 22 such as a flash memory. Accordingly, when the captured digital image is previewed by means of a display of the digital still camera or a computer, or developed or printed as a photo, the aspect-ratio information will be automatically realized. Therefore, an expected view conforming to the photograph specification is able to be obtained. The embodiments of patterns shown on the view-finding device, e.g. viewfinder or LCD panel, according to the present invention will be illustrated with reference to FIGS. 3 and 4 in more details.

In FIGS. 3(a) and 3(b), a plurality of predetermined aspect ratios, e.g. aspect ratios of 4 by 3 (4×3), 5 by 3 (3×5), 6 by 4 (4×6), etc., are provided for selection via the input interface 20. In response to the selected aspect ratio, the micro-controller 21 has the image frame to be marked in a specific pattern. For example, the image frame 30 displayed on the viewfinder 10 and/or the liquid crystal display 11 is marked with a relatively bright portion and a relatively dark portion to show a desired frame portion 301 and an undesired frame portion 302, respectively. It is understood the darkened portion for 3×5 photo specification will be larger in size than that for 4×6 one. If the aspect ration of the image frame captured by the digital still camera is not to be adjusted, the aspect ratio 3×4 is selected and no darkened portion is required. Since the desired frame portion 301 viewed by the user is adjusted to conform to the photograph specification, the problems resulting from the unmatched aspect ratios of the viewed frame and the real photograph in the prior art are effectively overcome. Then, a digital image data file of the image frame incorporating therein the information associated with the aspect ratio is stored into the storage unit 22.

Another embodiment of the pattern is shown in FIGS. 4(a) and 4(b). The image frames 40 displayed on the viewfinder 10 and/or the liquid crystal display 11 are marked with segmental symbols S1 and S2 for 3×5 and 4×6 photos, respectively, to show desired frame portions 401. Since the desired frame portions 401 confined by the segmental symbols S1 and S2 are adjusted to conform to the photograph specification, the problems resulted from the unmatched aspect ratios of the viewed frame and the real photograph in the prior art are effectively overcome. Alternatively, as shown in FIG. 4(c), two segmental symbols S1 and S2 can be simultaneously marked on the image frames 40 to define two frame portions corresponding to the predetermined aspect ratios, for example 5 by 3 and 6 by 4. In this way, the user can clearly see what will the 3×4, 3×5 and 4×6 photos be in the same image frame.

From the above description, the view-finding device and method of the present invention are capable of permitting flexible adjustment of the aspect ratio of a frame viewed thereby according to the desired photo specification. In addition, for enhancing user's convenience, the digital image data file of the image frame needs not to be downloaded and processed by a computer in advance but directly previewed by the digital still camera. When the captured digital image is to be developed or printed, according to the selected aspect ratio that is preferably incorporated into the data file of the captured image, an image-outputting apparatus will output an image frame conforming to the photograph specification as a photo.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A view-finding method of an image-capturing apparatus, comprising steps of:
selecting a desired one from a plurality of predetermined aspect ratios; and
showing an image frame to be taken by said image-capturing apparatus and
marking on said image frame according to said selected aspect ratio to distinguish a desired frame portion from the other frame portion.

2. The method according to claim 1 wherein said step of selecting said desired aspect ratio is performed by the user via an input interface.

3. The method according to claim 2 wherein said input interface is a button.

4. The method according to claim 1 wherein said image-capturing apparatus is a digital still camera or a digital video camera for obtaining a digital data file of said image frame.

5. The method according to claim 4 wherein digital information associated with said selected aspect ratio is recorded into said digital data file to be outputted to a display or a printer.

6. The method according to claim 1 wherein said image frame is marked with a relatively bright and a relatively dark portions to show said desired frame portion and an undesired frame portion, respectively.

7. The method according to claim 1 wherein said image frame is marked with segmental symbols to define said desired frame portion.

8. A view-finding device of an image-capturing apparatus, comprising:
an image display window showing an image frame to be taken by said image-capturing apparatus;
an input interface allowing a user to give a command therevia for designating an aspect ratio; and
a micro-controller in communication with said input interface, having said image frame to be marked in a specific pattern in response to said command.

9. The view-finding device according to claim 8 further comprising a storage unit for storing a digital image data file of said image frame, which incorporates therein the information associated with said aspect ratio.

10. The view-finding device according to claim 9 wherein said storage unit is a flash memory.

11. The view-finding device according to claim 8 wherein said input interface is a button.

12. The view-finding device according to claim 8 wherein said image display window is a viewfinder or a liquid crystal display.

13. The view-finding device according to claim 8 wherein said image frame is marked with a relatively bright and a relatively dark portions to show a desired frame portion and an undesired frame portion, respectively.

14. The view-finding device according to claim 8 wherein said image frame is marked with segmental symbols to define a desired frame portion.

15. The view-finding device according to claim 8 wherein said image-capturing apparatus is one of a digital still camera and a video camera.

16. A view-finding device of an image-capturing apparatus, comprising an image display window showing an image frame to be taken by said image-capturing apparatus, wherein said image frame is marked thereon with plural sets of symbols to define a plurality of frame portions corresponding to a plurality of predetermined aspect ratios.

17. The view-finding device according to claim 16 wherein said image display window is a viewfinder or a liquid crystal display.

18. The view-finding device according to claim 16 wherein said image-capturing apparatus is one of a digital still camera and a video camera.

19. The view-finding device according to claim 16 wherein said symbols are segmental symbols.
